(19) United States
(12) Patent Application Publication
(10) Pub. No.: US 2018/0183672 A1
(43) Pub. Date: Jun. 28, 2018

(54) SYSTEM AND METHOD FOR GROUPING OF NETWORK ON CHIP (NOC) ELEMENTS

(71) Applicant: NetSpeed Systems, Inc., San Jose, CA (US)

(72) Inventors: Eric NORIGE, San Jose, CA (US); Sailesh KUMAR, San Jose, CA (US)

(21) Appl. No.: 15/903,572

(22) Filed: Feb. 23, 2018

Related U.S. Application Data
(63) Continuation of application No. 14/743,749, filed on Jun. 18, 2015.

(51) Int. Cl. H04L 12/24; H04L 12/713; H04L 12/721; H04L 12/933

(52) U.S. Cl. CPC H04L 41/0893; H04L 45/586; H04L 45/06; H04L 41/082; H04L 49/109

(57) ABSTRACT

Aspects of the present disclosure are directed to systems, methods and computer readable medium for reducing the number of unique routers/network elements/module instances on a network on chip to get a simplified NoC RTL without effecting the behavior and performance of NoC. According to an example implementation of the present disclosure, plurality of NoC elements of a given NoC can be grouped together to form one or more groups, and one or more superset NoC elements/module instances encompassing capabilities/functionalities of plurality of individual NoC elements of said one or more groups can be determined/created for each of the said one or more groups. In an example implementation, the NoC can be represented by replacing plurality of NoC elements with the created superset NoC elements/module instances, which may reduce the number of unique module instances within an application specific network on chip or system of chip.

This regular U.S. patent application is a continuation application of U.S. patent application Ser. No. 14/743,749, filed Jun. 18, 2015, the entire disclosure of which is incorporated by reference herein.

### BACKGROUND

### Technical Field

Methods and example implementations described herein are directed to interconnect architecture, and more specifically, to reduction of unique module instances by grouping of Network on Chip (NoC) elements within an application specific Network on Chip (NoC).

### Related Art

The number of components on a chip is rapidly growing due to increasing levels of integration, system complexity and shrinking transistor geometry. Complex System-on-Chips (SoCs) may involve a variety of components e.g., processor cores, Digital Signal Processors (DSPs), hardware accelerators, memory and I/O, while Chip Multi-Processors (CMPs) may involve a large number of homogenous processor cores, memory and I/O subsystems. In both SoC and CMP systems, the on-chip interconnect plays a role in providing high-performance communication between the various components. Due to scalability limitations of traditional buses and crossbar based interconnects, Network-on-Chip (NoC) has emerged as a paradigm to interconnect a large number of components on the chip. NoC is a global shared communication infrastructure made up of several routing nodes interconnected with each other using point-to-point physical links.

Messages are injected by the source and are routed from the source node to the destination over multiple intermediate nodes and physical links. The destination node then ejects the message and provides the message to the destination. For the remainder of this application, the terms ‘components’, ‘blocks’, ‘hosts’ or ‘cores’ will be used interchangeably to refer to the various system components which are interconnected using a NoC. Terms ‘routers’ and ‘nodes’ will also be used interchangeably. Without loss of generalization, the system with multiple interconnected components will itself be referred to as a ‘multi-core system’.

There are several topologies in which the routers can connect to one another to create the system network. Bi-directional rings (as shown in FIG. 1(a)), 2-D (two dimensional) mesh (as shown in FIGS. 1(b)) and 2-D Taurus (as shown in FIG. 1(c)) are examples of topologies in the related art. Mesh and Taurus can also be extended to 2.5-D (two and half dimensional) or 3-D (three dimensional) organizations. FIG. 1(d) shows a 3D mesh NoC, where there are three layers of 3×3 2D mesh NoC shown over each other. The NoC routers have up to two additional ports, one connecting to a router in the higher layer, and another connecting to a router in the lower layer. Router 111 in the middle layer of the example has both ports used, one connecting to the router at the top layer and another connecting to the router at the bottom layer. Routers 110 and 112 are at the bottom and top mesh layers respectively, therefore they have only the upper facing port 113 and the lower facing port 114 respectively connected.

Packets are message transport units for intercommunication between various components. Routing involves identifying a path composed of a set of routers and physical links of the network over which packets are sent from a source to a destination. Components are connected to one or multiple ports of one or multiple routers; with each such port having a unique ID. Packets carry the destination's router and port ID for use by the intermediate routers to route the packet to the destination component.

Examples of routing techniques include deterministic routing, which involves choosing the same path from A to B for every packet. This form of routing is independent from the state of the network and does not load balance across path diversities, which might exist in the underlying network. However, such deterministic routing may implemented in hardware, maintains packet ordering and may be rendered free of network level deadlocks. Shortest path routing may minimize the latency as such routing reduces the number of hops from the source to the destination. For this reason, the shortest path may also be the lowest power path for communication between the two components. Dimension-order routing is a form of deterministic shortest path routing in 2-D, 2.5-D, and 3-D mesh networks. In this routing scheme, messages are routed along each coordinates in a particular sequence until the message reaches the final destination. For example in a 3-D mesh network, one may first route along the X dimension until it reaches a router whose X-coordinate is equal to the X-coordinate of the destination router. Next, the message takes a turn and is routed in along Y dimension and finally takes another turn and moves along the Z dimension until the message reaches the final destination router. Dimension ordered routing may be minimal turn and shortest path routing.

FIG. 2(a) pictorially illustrates an example of XY routing in a two dimensional mesh. More specifically, FIG. 2(a) illustrates XY routing from node ‘34’ to node ‘00’. In the example of FIG. 2(a), each component is connected to only one port of one router. A packet is first routed over the x-axis till the packet reaches node ‘04’ where the x-coordinate of the node is the same as the x-coordinate of the destination node. The packet is next routed over the y-axis until the packet reaches the destination node.

In heterogeneous mesh topology in which one or more routers or one or more links are absent, dimension order routing may not be feasible between certain source and destination nodes, and alternative paths may have to be taken. The alternative paths may not be shortest or minimum turn.

Source routing and routing using tables are other routing options used in NoC. Adaptive routing can dynamically change the path taken between two points on the network based on the state of the network. This form of routing may be complex to analyze and implement.

A NoC interconnect may contain multiple physical networks. Over each physical network, there may exist multiple virtual networks, wherein different message types are transmitted over different virtual networks. In this case, at each physical link or channel, there are multiple virtual channels; each virtual channel may have dedicated buffers at both end points. In any given clock cycle, only one virtual channel can transmit data on the physical channel.

NoC interconnects may employ wormhole routing, wherein, a large message or packet is broken into small pieces known as flits (also referred to as flow control digits). The first flit is the header flit, which holds information about this packet's route and key message level info along with payload data and sets up the routing behavior for all subsequent flits associated with the message. Optionally, one or more body flits follows the head flit, containing the remaining payload of data. The final flit is the tail flit, which in addition to containing the last payload also performs some bookkeeping to close the connection for the message. In wormhole flow control, virtual channels are often implemented.

The physical channels are time sliced into a number of independent logical channels called virtual channels (VCs). VCs provide multiple independent paths to route packets, however they are time-multiplexed on the physical channels. A virtual channel holds the state needed to coordinate the handling of the flits of a packet over a channel. At a minimum, this state identifies the output channel of the current node for the next hop of the route and the state of the virtual channel (idle, waiting for resources, or active). The virtual channel may also include pointers to the flits of the packet that are buffered on the current node and the number of flit buffers available on the next node.

The term “wormhole” plays on the way messages are transmitted over the channels: the output port at the next router can be so short that received data can be translated in the head flit before the full message arrives. This allows the router to quickly set up the route upon arrival of the head flit and then opt out from the rest of the conversation. Since a message is transmitted flit by flit, the message may occupy several flit buffers along its path at different routers, creating a worm-like image.

Based upon the traffic between various end points, and the routes and physical networks that are used for various messages, different physical channels of the NoC interconnect may experience different levels of load and congestion. The capacity of various physical channels of a NoC interconnect is determined by the width of the channel (number of physical wires) and the clock frequency at which it is operating. Various channels of the NoC may operate at different clock frequencies, and various channels may have different widths based on the bandwidth requirement at the channel. The bandwidth requirement at a channel is determined by the flows that traverse over the channel and their bandwidth values. Flows traversing over various NoC channels are affected by the routes taken by various flows. In a mesh or Taurus NoC, there may exist multiple route paths of equal length or number of hops between any pair of source and destination nodes. For example, in FIG. 2(b), in addition to the standard XY route between nodes 34 and 00, there are additional routes available, such as YX route 203 or a multi-turn route 202 that makes more than one turn from source to destination.

In a NoC with statically allocated routes for various traffic slows, the load at various channels may be controlled by intelligently selecting the routes for various flows. When a large number of traffic flows and substantial path diversity is present, routes can be chosen such that the load on all NoC channels is balanced nearly uniformly, thus avoiding a single point of bottleneck. Once routed, the NoC channel widths can be determined based on the bandwidth demands of flows on the channels. Unfortunately, channel widths cannot be arbitrarily large due to physical hardware design restrictions, such as timing or wiring congestion. There may be a limit on the maximum channel width, thereby putting a limit on the maximum bandwidth of any single NoC channel.

Additionally, wider physical channels may not help in achieving higher bandwidth if messages are short. For example, if a packet is a single flit packet with a 64-bit width, then no matter how wide a channel is, the channel will only be able to carry 64 bits per cycle of data if all packets over the channel are similar. Thus, a channel width is also limited by the message size in the NoC. Due to these limitations on the maximum NoC channel width, a channel may not have enough bandwidth in spite of balancing the routes.

To address the above bandwidth concern, multiple parallel physical NoCs may be used. Each NoC may be called a layer, thus creating a multi-layer NoC architecture. Hosts inject a message on a NoC layer; the message is then routed to the destination on the NoC layer, where it is delivered from the NoC layer to the host. Thus, each layer operates more or less independently from each other, and interactions between layers may only occur during the injection and ejection times. FIG. 3(a) illustrates a two layer NoC. Here the two NoC layers are shown adjacent to each other on the left and right, with the hosts connected to the NoC replicated in both left and right diagrams. A host is connected to two routers in this example—a router in the first layer shown as R1, and a router is the second layer shown as R2. In this example, the multi-layer NoC is different from the 3D NoC, i.e. multiple layers are on a single silicon die and are used to meet the high bandwidth demands of the communication between hosts on the same silicon die. Messages do not go from one layer to another. For purposes of clarity, the present application will utilize such a horizontal left and right illustration for multi-layer NoC to differentiate from the 3D NoCs, which are illustrated by drawing the NoCs vertically over each other.

In FIG. 3(b), a host connected to a router from each layer, R1 and R2 respectively, is illustrated. Each router is connected to other routers in its layer using directional ports 301, and is connected to the host using injection and ejection ports 302. Abridge-logic 303 may sit between the host and the two NoC layers to determine the NoC layer for an outgoing message and sends the message from host to the NoC layer, and also perform the arbitration and multiplexing between incoming messages from the two NoC layers and delivers them to the host.

In a multi-layer NoC, the number of layers needed may depend upon a number of factors such as the aggregate bandwidth requirement of all traffic flows in the system, the routes that are used by various flows, message size distribution, maximum channel width, etc. Once the number of NoC layers in NoC interconnect is determined in a design, different messages and traffic flows may be routed over different NoC layers. Additionally, one may design NoC interconnects such that different layers have different topologies in number of routers, channels and connectivity. The channels in different layers may have different widths based on the flows that traverse over the channel and their bandwidth requirements.

In a NoC interconnect, if the traffic profile is not uniform and there is a certain amount of heterogeneity (e.g., certain hosts talking to each other more frequently than the others), the interconnect performance may depend on the NoC topology and where various hosts are placed in the topology with respect to each other and to what routers they are connected to. For example, if two hosts talk to each other frequently and require higher bandwidth than other interconnects, then they should be placed next to each other. This reduces the latency for this communication, which thereby reduces global average latency as well as reduces the number of router nodes and links over which the higher bandwidth of this communication must be provisioned.

With an increasing number of components/elements/modules on chip, placement, synthesization, and operation of NoC elements/components/modules may become more complex. For example, it may become more difficult to synthesize even a simplified network on chip (NoC) or a segment of NoC having three identical CPU tiles (T1, T2, and T3) connected to routers (R1, R2, and R3), which routers are in turn connected to each other. When the example chip or segment of chip needs to be synthesized, a possible way can include synthesizing all the tiles T individually, then synthesizing all individual routers, for instance R1, R2, and R3 individually, and then placing the tiles and routers together, for instance T+R1, T+R2, and T+R3. However, atypical NoC/SoC may have thousands of network elements/components/modules and hundreds of tiles, and if such a NoC/SoC needs to be synthesized for optimal design and performance, a large number of elements/modules may need to be synthesized which becomes complex.

### SUMMARY

Therefore, it is desired to reduce/minimize the number of routers/network elements/module instances on NoC, without affecting performance/behavior of the NoC/SoC.

Therefore, there is a need for systems and methods that enable reduction in the number of unique module instances within an application specific network on chip (NoC) or system on chip (SoC)in order to get a simplified NoC RTL (Register Transfer-Level), without affecting actual behavior and/or performance of the NoC/SoC.

Aspects of the present disclosure are directed to systems and methods for reducing the number of unique routers/network elements/module instances on a network on chip (NoC) to get a simplified NoC RTL without affecting the behavior and performance of NoC. According to an example implementation of the present disclosure, a plurality of NoC elements of a given NoC can be grouped together based on one or more parameters to form one or more groups, wherein, for each group, a superset NoC element/module instance that encompasses capabilities/functionalities of individual NoC elements of the respective group can be determined/created. In an example implementation, each NoC element of each group can be replaced by the superset NoC element/module instance that corresponds the group so as to reduce the number of unique module instances within an application specific network on chip (NoC) or system of chip (SoC).

An aspect of the present application is directed to a method for reducing the number of unique module instances to represent a NoC, the method including the steps of; grouping a plurality of NoC elements into one or more groups, determining a superset NoC element for each of the one or more groups, wherein the superset NoC element can be configured to encompass behaviors/capabilities/functionalities of plurality of NoC elements of the corresponding group, and representing the NoC through replacement of each of the plurality of NoC elements with the superset NoC element corresponding to the group from said one or more groups.

In an example implementation, a user can provide one or more inputs for reducing the number of unique modules, such as, an indication of plurality of NoC elements that can be grouped together, number of unique module instances with which the NoC can be represented or the number of unique instances that are desired, hierarchy of NoC elements/unique module instances, local/global cost constraints, routing information of one or more NoC elements, power profile of NoC elements, traffic profile of NoC elements and other descriptions/limitations/constraints of the NoC. In another example implementation, method of the present disclosure can automatically group together one or more NoC elements to form one or more groups and then determine superset NoC element(s) based on the similarity/compatibility of properties of one or more NoC elements.

According to an example implementation of the present disclosure, the superset NoC elements can be constructed/created/determined based on one or more of, merging properties of compatible channels of the plurality of NoC elements of the corresponding group, resolving internal connectivity of channels into a superset connectivity, and merging of routing information associated with the plurality of NoC elements.

According to an example implementation, a compatible channel can include compatible ports and compatible virtual channels of the NoC elements that can be merged together. In an example implementation, merging of properties of compatible channels can include increasing/optimizing depth of virtual channel(s),increasing/optimizing width of virtual channel(s), enabling one or more channels/ports, increasing/optimizing buffer size of one or more ports of the superset NoC elements, such that increased/optimized channel properties encompasses all properties/capabilities of each of the plurality of NoC element's channels and ports. In an example implementation, resolving internal connectivity can include the steps of, determining and resolving one or more conflicting paths/connectivity, and enabling one or more connectivity/paths of the superset NoC elements.

In example implementations, merging of routing information associated with plurality of NoC elements can include the steps of forming a consolidated routing table or routing logic for superset NoC elements incorporating all routing information and routing logic of the plurality of NoC elements of a particular group. In an example implementation, merging of routing information associated with the plurality of NoC elements can be based on identifier tags assigned to each NoC element and storing relating routing information corresponding to all NoC elements, which indicates specific routing information for a particular NoC element of the group.

According to an example implementation, grouping of the plurality of NoC elements into one or more groups can be based on a user defined or system generated hierarchy of the NoC elements. In an example implementation, hierarchy of the plurality of NoC elements can either be determined/defined by user specification of hierarchical groups of NoC elements to be merged, or can be determined by automatic inference of hierarchical groups to merge from hierarchical group properties of NoC elements.

According to an example implementation of the present disclosure, grouping of plurality NoC elements can be based on a user defined local/global cost limit, or user defined number of desired unique elements, or user defined hierarchy information. In an example implementation, method of the present disclosure can be used to merge one or more groups into one or more superset NoC elements based on user defined criteria/limits or user selection of NoC elements for creating one or more groups.

In an example implementation, a recursive/greedy/opportunistic algorithm can be used for grouping plurality of NoC elements so that a group can be created by recursively adding a NoC element and repeatedly calculating total cost of grouping, until either the total number of NoC elements that can be added in a particular group exceeds a preselected limit, or the total cost of grouping reaches a predefined limit. In a recursive implementation, the cost of group can be repeatedly calculated when a new NoC element is added in a particular group and a new NoC element can be recursively added until the total cost of said group exceeds a predefined limit or the total number of unique NoC element added in the group exceeds a predefined limit of number of NoC elements selected for a particular group.

According to an example implementation, after replacing/representing the NoC with superset NoC elements or with minimized module instances, method of the present disclosure can further resolve connectivity conflicts between the one or more superset NoC elements and the plurality of NoC elements adjacent to the superset NoC elements.

An aspect of the present disclosure is directed to a system for reducing the number of unique module instances to represent a NoC in simplified form. The system can optionally include a user interface module configured to receive user selection of NoC elements to form one or more groups, and other specification/limitation/criteria of NOC from user, a NoC grouping module configured to group plurality of NoC elements into one or more groups based on the user selection of NoC elements and other given limitations, a superset NoC element determination module configured to determine a superset NoC element for each of the one or more groups, wherein the superset NoC element can be configured to encompass behaviors/capabilities/functionalities of plurality of NoC elements in a corresponding group, and a replacement module configured to represent the NoC through replacement of each of the plurality of NoC elements with the superset NoC element corresponding to a particular group from said one or more groups.

Aspects of the present disclosure further relate to a non-transitory computer readable medium, storing instructions for executing a process of grouping a plurality of NoC elements into one or more groups, determining a superset NoC element for each of the one or more groups, wherein the superset NoC element can be configured to encompass behavior/capabilities/functionalities of plurality of NoC elements in its corresponding group, and representing the NoC through replacement of each of the plurality of NoC elements with the superset NoC element corresponding to the group from said one or more groups.

### BRIEF DESCRIPTION OF THE DRAWINGS

In the Figures, similar components and/or features may have the same reference label. Further, various components of the same type may be distinguished by following the reference label with a second label that distinguishes among the similar components. If only the first reference label is used in the specification, the description is applicable to any one of the similar components having the same first reference label irrespective of the second reference label.

FIGS. 1(a), 1(b) 1(c) and 1(d) illustrate examples of Bidirectional ring, 2D Mesh, 2D Taurus, and 3D Mesh NoC Topologies.

FIG. 2(a) illustrates an example of XY routing in a related art two dimensional mesh.

FIG. 2(b) illustrates three different routes between a source and destination nodes.

FIG. 3(a) illustrates an example of a related art two layer NoC interconnect.

FIG. 3(b) illustrates the related art bridge logic between host and multiple NoC layers.

FIG. 4(a) illustrates an example input network on chip that can be simplified by reducing the number of module instances in accordance with an example implementation of the present disclosure.

FIG. 4(b) illustrates an example simplified NoC RTL in accordance with an example implementation of the present disclosure.

FIGS. 5(a) to 5(c) illustrate another example of grouping of NoC elements and replacement of NoC elements of each group by a superset NoC element of that group in accordance with an example implementation of the present disclosure.

FIG. 6 illustrates an example flow diagram of a method for reducing the number of unique module instances to represent a NoC in accordance with an example implementation of the present disclosure.

FIG. 7 illustrates an example connectivity resolution of superset NoC element created in accordance with an example implementation of the present disclosure.

FIG. 8 illustrates progressive bit matrix representation for resolving connectivity conflict in accordance with an example implementation of the present disclosure.

FIG. 9 illustrates input NoC elements that can be merged to generate a superset element in accordance with an example implementation of the present disclosure.

FIG. 10 illustrates an example computer system on which example implementation can be present disclosure can be executed in accordance with an example implementation of the present disclosure.

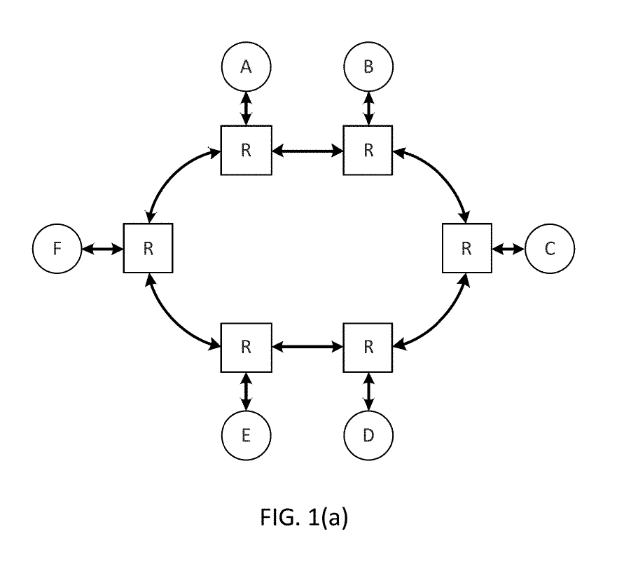

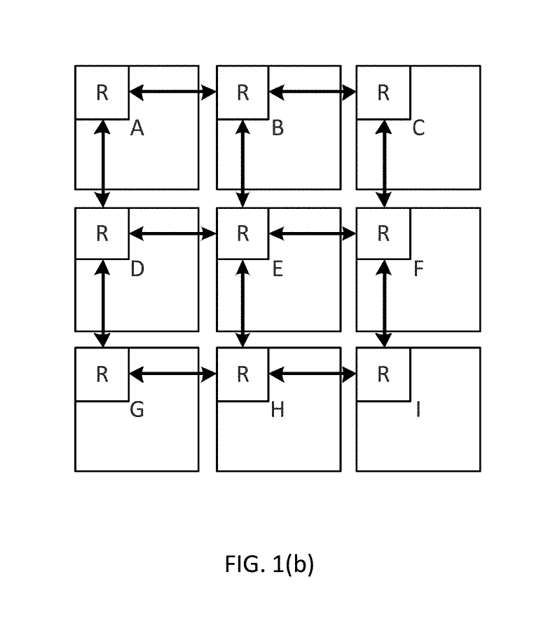

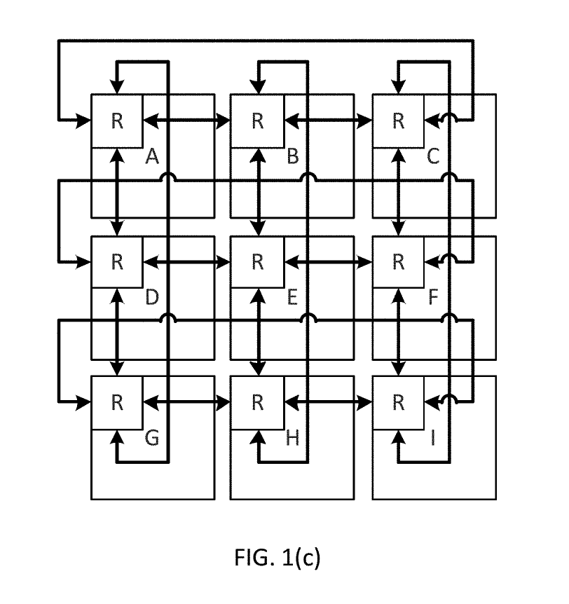

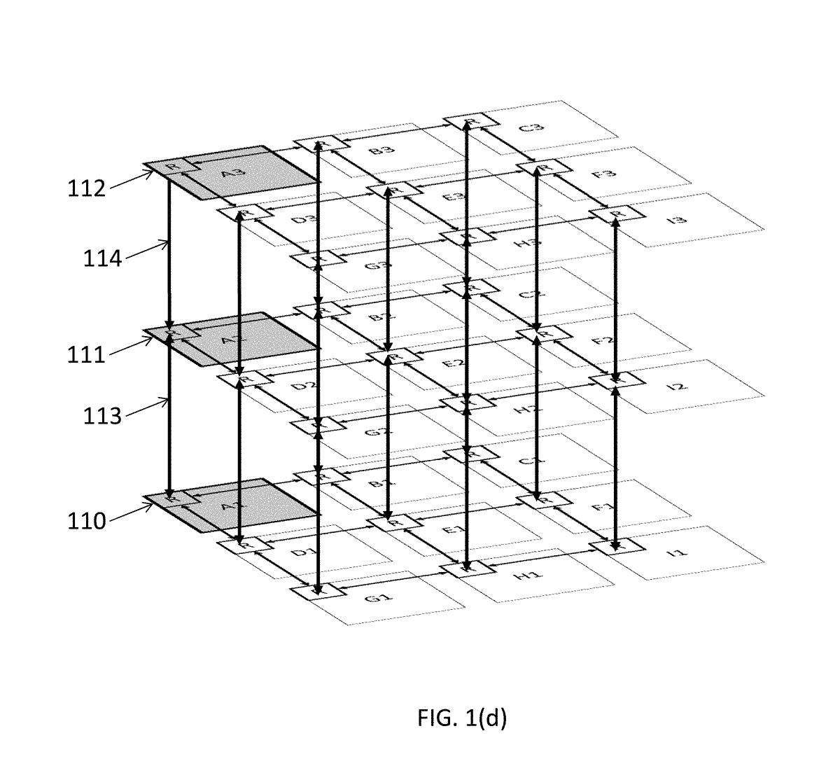

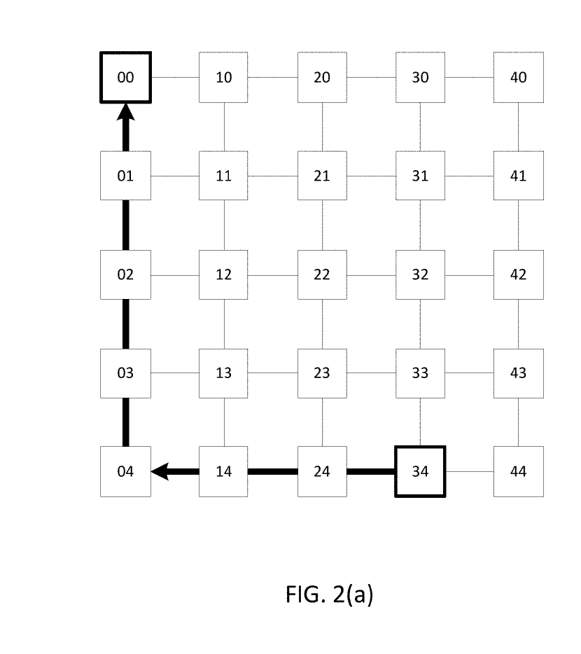

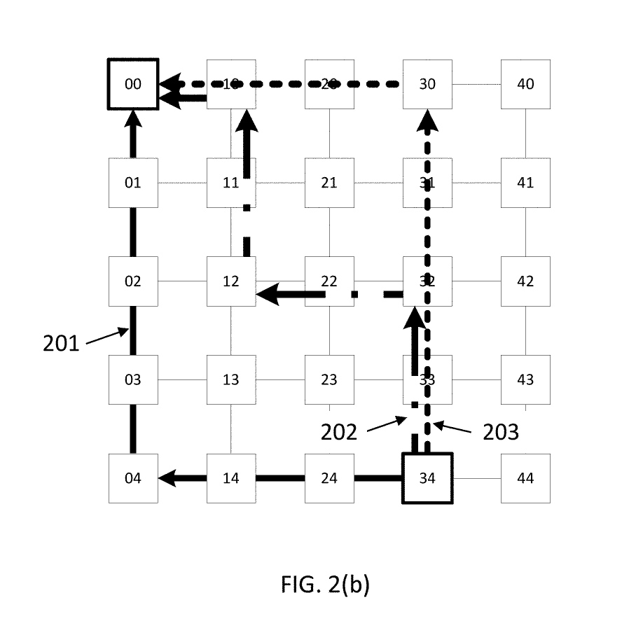

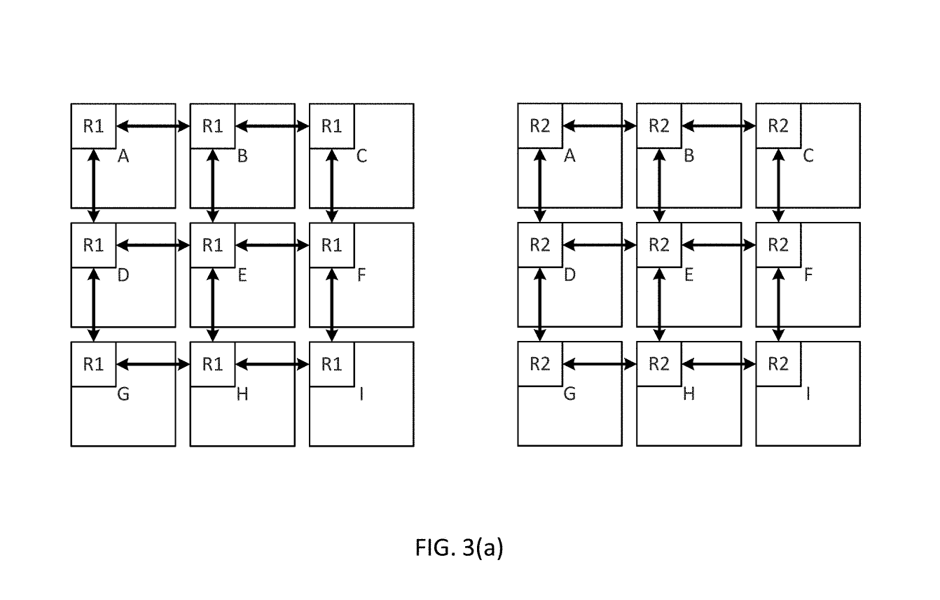

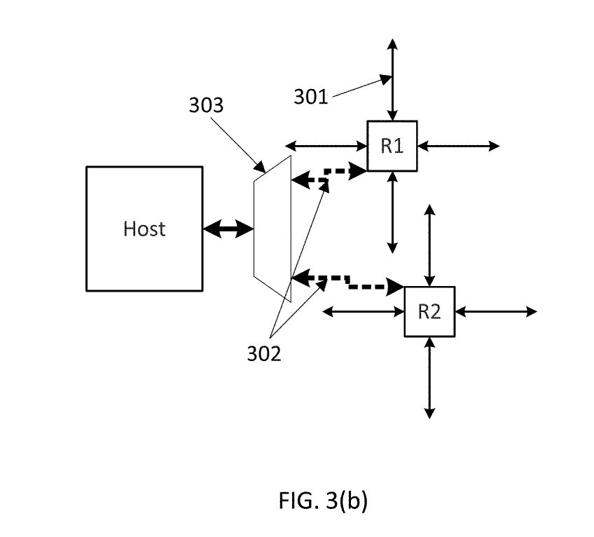

### DETAILED DESCRIPTION

The following detailed description provides further details of the figures and example implementations of the present application. Reference numerals and descriptions of redundant elements between figures are omitted for clarity. Terms used throughout the description are provided as examples and are not intended to be limiting. For example, the use of the term “automatic” may involve fully automatic or semi-automatic implementations involving user or administrator control over certain aspects of the implementation, depending on the desired implementation of one of ordinary skill in the art practicing implementations of the present application.

In the present disclosure different terms such as modules or component or NoC element, network elements or routers or switches are interchangeably used to mean a NoC network element.

Aspects of the present disclosure are directed to systems and methods for reducing the number of unique routers/network elements/module instances on a network on chip (NoC) to get a simplified NoC RTL without affecting the behavior and performance of NoC. According to an example implementation of the present disclosure, a plurality of NoC elements of a given NoC can be grouped together based on one or more parameters to form one or more groups, wherein, for each group, a superset NoC element/module instance that encompasses capabilities/functionalities of individual NoC elements of the respective group can be determined/created. In an example implementation, each NoC element of each group can be replaced by the superset NoC element/module instance that corresponds the group so as to reduce the number of unique module instances within an application specific network on chip (NoC) or system of chip (SoC).

An aspect of the present application is directed to a method for reducing the number of unique module instances to represent a NoC, the method including the steps of; grouping a plurality of NoC elements into one or more groups, determining a superset NoC element for each of the one or more groups, wherein the superset NoC element can be configured to encompass behaviors/capabilities/functionalities of plurality of NoC elements of the corresponding group, and representing the NoC through replacement of each of the plurality of NoC elements with the superset NoC element corresponding to the group from said one or more groups.

In an example implementation, a user can provide one or more inputs for reducing the number of unique modules, such as, an indication of plurality of NoC elements that can be grouped together, number of unique module instances with which the NoC can be represented or the number of unique instances that are desired, hierarchy of NoC elements/unique module instances, local/global cost constraints, routing information of one or more NoC elements, power profile of NoC elements, traffic profile of NoC elements and other descriptions/limitations/constraints of the NoC. In another example implementation, method of the present disclosure can automatically group together one or more NoC elements to form one or more groups and then determine superset NoC element(s) based on the similarity/compatibility of properties of one or more NoC elements.

According to an example implementation of the present disclosure, the superset NoC elements can be constructed/created/determined based on one or more of, merging properties of compatible channels of the plurality of NoC elements of the corresponding group, resolving internal connectivity of channels into a superset connectivity, and merging of routing information associated with the plurality of NoC elements.

According to an example implementation, a compatible channel can include compatible ports and compatible virtual channels of the NoC elements that can be merged together. In an example implementation, merging of properties of compatible channels can include increasing/optimizing depth of virtual channel(s), increasing/optimizing width of virtual channel(s), enabling one or more channels/ports, increasing/optimizing buffer size of one or more ports of the superset NoC elements, such that increased/optimized channel properties encompasses all properties/capabilities of each of the plurality of NoC element's channels and ports. In an example implementation, resolving internal connectivity can include the steps of, determining and resolving one or more conflicting paths/connectivity, and enabling one or more connectivity/paths of the superset NoC elements.

In example implementations, merging of routing information associated with plurality of NoC elements can include the steps of forming a consolidated routing table or routing logic for superset NoC elements incorporating all routing information and routing logic of the plurality of NoC elements of a particular group. In an example implementation, merging of routing information associated with the plurality of NoC elements can be based on identifier tags assigned to each NoC element and storing relating routing information corresponding to all NoC elements, which indicates specific routing information for a particular NoC element of the group.

According to an example implementation, grouping of the plurality of NoC elements into one or more groups can be based on a user defined or system generated hierarchy of the NoC elements. In an example implementation, hierarchy of the plurality of NoC elements can either be determined/defined by user specification of hierarchical groups of NoC elements to be merged, or can be determined by automatic inference of hierarchical groups to merge from hierarchical group properties of NoC elements.

According to an example implementation of the present disclosure, grouping of plurality NoC elements can be based on a user defined local/global cost limit, or user defined number of desired unique elements, or user defined hierarchy information. In an example implementation, method of the present disclosure can be used to merge one or more groups into one or more superset NoC elements based on user defined criteria/limits or user selection of NoC elements for creating one or more groups.

In an example implementation, a recursive/greedy/opportunistic algorithm can be used for grouping plurality of NoC elements so that a group can be created by recursively adding a NoC element and repeatedly calculating total cost of grouping, until either the total number of NoC elements that can be added in a particular group exceeds a preselected limit, or the total cost of grouping reaches a predefined limit. In a recursive implementation, the cost of group can be repeatedly calculated when a new NoC element is added in a particular group and a new NoC element can be recursively added until the total cost of said group exceeds a predefined limit or the total number of unique NoC element added in the group exceeds a predefined limit of number of NoC elements selected for a particular group.

According to an example implementation, after replacing/representing the NoC with superset NoC elements or with minimized module instances, method of the present disclosure can further resolve connectivity conflicts between the one or more superset NoC elements and the plurality of NoC elements adjacent to the superset NoC elements. In an aspect, connectivity between the superset NoC element and the plurality of NoC elements adjacent to the superset NoC elements can be resolved by modification of the plurality of NoC elements that are not part of the group to be replaced by the superset. In another aspect, connectivity between the superset NoC element and the plurality of NoC elements adjacent to the superset NoC elements can be resolved by reprocessing the plurality of NoC elements that are merged into another superset element that interact with the plurality of NoC elements in the group to be replaced by the superset.

An aspect of the present disclosure is directed to a system for reducing the number of unique module instances to represent a NoC in simplified form. The system can optionally include a user interface module configured to receive user selection of NoC elements to form one or more groups, and other specification/limitation/criteria of NOC from user, a NoC grouping module configured to group plurality of NoC elements into one or more groups based on the user selection of NoC elements and other given limitations, a superset NoC element determination module configured to determine a superset NoC element for each of the one or more groups, wherein the superset NoC element can be configured to encompass behaviors/capabilities/functionalities of plurality of NoC elements in a corresponding group, and a replacement module configured to represent the NoC through replacement of each of the plurality of NoC elements with the superset NoC element corresponding to a particular group from said one or more groups.

Aspects of the present disclosure further relate to a non-transitory computer readable medium, storing instructions for executing a process of grouping a plurality of NoC elements into one or more groups, determining a superset NoC element for each of the one or more groups, wherein the superset NoC element can be configured to encompass behavior/capabilities/functionalities of plurality of NoC elements in its corresponding group, and representing the NoC through replacement of each of the plurality of NoC elements with the superset NoC element corresponding to the group from said one or more groups.

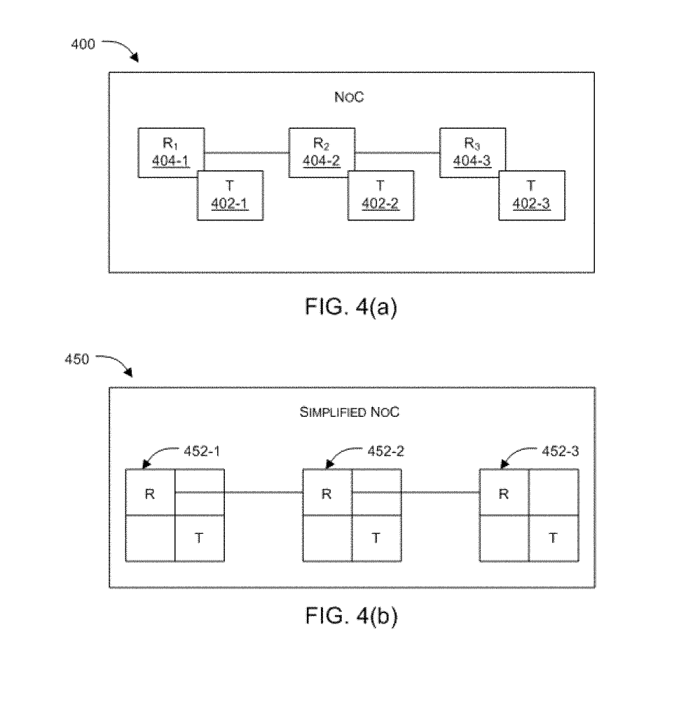

FIG. 4(a) illustrates an example input network on chip 400 that can be simplified by reducing the number of module instances in accordance with an example implementation of the present disclosure. As illustrated in FIG. 4(a), an input NoC 400 has three identical CPU tiles T1 402-1, T2 402-2, and T3 402-2, connected to routers R1 402-1, R2 402-2 and R3 402-3 respectively. The tiles T1 402-1, T2 402-2, and T3 402-2 are collectively and interchangeably hereinafter referred as tiles T 402, and the routers R1 402-1, R2 402-2 and R3 402-3 are collectively and interchangeably hereinafter referred as routers R 402. As apparent in the figure, routers R1 402-1, R2 402-2 and R3 402-3 are interconnected through a suitable path. To synthesize the example NoC 400, the tiles T 402 can all be synthesized individually or all of the individual routers can be synthesized individually (e.g. R1 404-1, R2 404-2, and R3 404-3) and can place tiles T 402 and routers R404 together, for instance T+R1, T+R2 and T+R3. The methods and systems of the present disclosure can be used to simplify the NoC by reducing the number of module instances/routers/network elements required to represent the NoC.

FIG. 4(b) illustrates an example simplified NoC RTL 450 in accordance with an example implementation of the present disclosure. As shown on the FIG. 4(b), the NoC 450 is a simplified representation of NoC 400 with a single superset router R that encompasses capability/functionality of all the individual routers R1 404-1, R2 404-2, and R3 404-3, and that can be placed together with all the tiles T. As shown in FIG. 4(b), routers R1 404-1, R 404-2, and R3 404-3 of NoC 400 can be replaced by a single router R in simplified NoC 450. In an example implementation, individual tiles and routers can be merged together to form a block of tiles and a superset router(T+R), such as block 452-1, block 452-2, and block 452-3 that can be synthesized and can represent input NoC 400 in a simplified form as NoC 450. An equivalent NoC 450 can be built that can have one router R, which is designed to encompass properties of all the individual routers R1, R2 and R3, and therefore can serve any tile T. Synthesizing the NoC 450 can be made trivial where only one superset router R needs to be synthesized and the combined tile and router R (T+R) can be placed on NoC three times as shown by blocks 452-1, 452-2 and 452-3. The equivalent NoC 450 having a superset router R has the same capability/functionality as compared to NoC 400 having three routers R1, R2 and R3. To represent a NoC in simplified form, methods and systems of the present disclosure therefore allow a reduced number of module instances to be used. Subsequent sections of the present disclosure describe example methods and systems in detail, which can be used to reduce the number of unique module instances for a given NoC to provide a simplified NoC without affecting its performance and/or behavior.

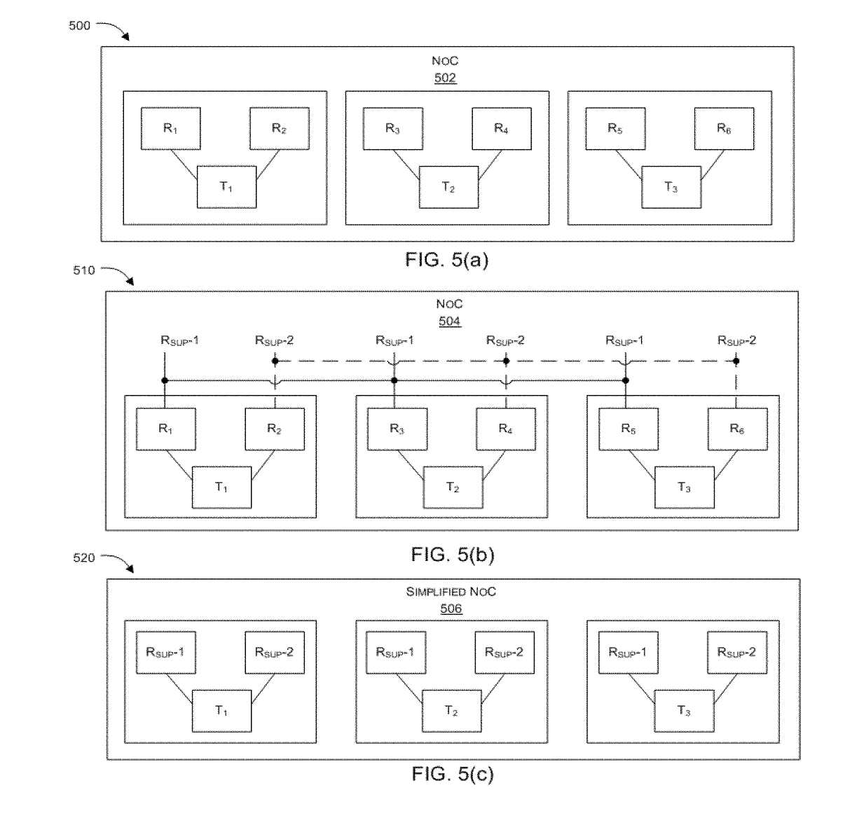

FIG. 5(a) illustrates an example input network on chip 502 having each of its tiles connected to two routers that can be simplified by reducing the number of routers/module instances of the NoC in accordance with an example implementation of the present disclosure. As shown in FIG. 5(a), the NoC 502 has three tiles T1, T2, and T3, each of them connected to two routers respectively. For example, tile T1 of NoC 502 is connected to router R1 and router R2, tile T2 of NoC 502 is connected to router R3 and router R4, and tile T3 of NoC 502 is connected to router R5 and router R6. In example implementations of NoC, one or more tiles can be connected to a plurality of routers, as different routers with which a particular tile is connected can have different properties/functionalities that may be desirable by the tiles. For example, router R1 and router R2 connected with tile T1 may have different properties, and such routers/network elements having different properties can't be grouped together, however they can be part of different groups based on one or more other similarity or compatibility. One or more routers from routers R1-R6 can be grouped together to form one or more groups that can be replaced with superset routers. In an example implementation, selection of router can be either user defined or can be auto generated based on one or more properties of routers.

FIG. 5(b) illustrates a group of NoC elements that can be grouped together in accordance with an example implementation of the present disclosure. As shown in FIG. 5(b), routers R1, R3, and R5 can form a first group that can be replaced by a first superset router Rsup-1, and routers R2, R4, and R6 can form a second group that can be replaced by a second superset router Rsup-2. As explained earlier, grouping of routers can be automated based on one or more properties of the routers. Using the method of present disclosure, entire NoC 504 can then be represented by two superset routers Rsup-1 and superset router Rsup-2, instead of using six routers (R1, R2, R3, R4, R5 and R6).

FIG. 5(c) illustrates an example simplified NoC 506 represented with two superset routers created in accordance with an example implementation of the present disclosure. As can be seen in FIG. 5(c), the NoC 506 is presented by only two routers, a first superset router Rsup-1 and a second superset router Rsup-2. The modified NoC 506 can be synthesized as it has a fewer number of unique routers/module instances that needs to be individually synthesized.

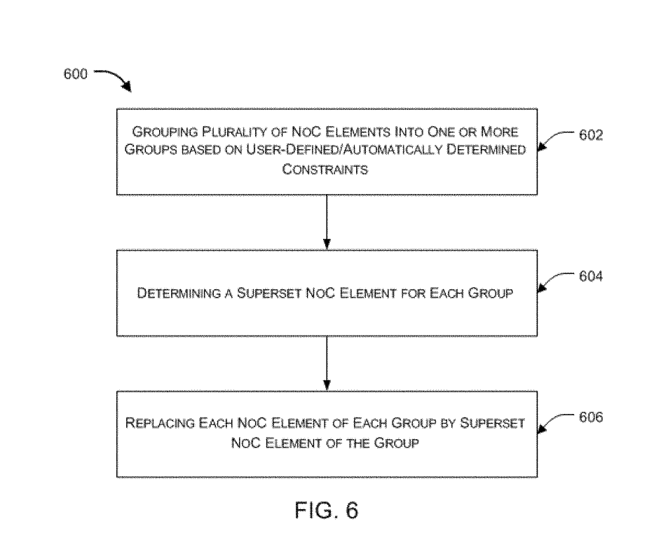

FIG. 6 illustrates an example flow diagram of a method for reducing the number of unique module instances to represent a NoC in accordance with an example implementation of the present disclosure. As shown in flow diagram 600, the method for reducing the number of unique module instance to represent a NoC can include, at 602, grouping a plurality of NoC elements into one or more groups based on user-defined and/or automatically determined constraints. For instance, this can further include, receiving from a user, a selection of NoC elements that can be grouped together to form one or more groups, along with receiving, for example, an indication of number of desired unique module instances with which the simplified NoC can be represented, and the NoC specification (such as traffic profile, power profile, etc.), among other limitations/constraints of NoC elements. At 604, a superset NoC element can be determined for each group of NoC elements such that the superset NoC element encompasses capabilities/functionalities of all the individual NoC elements that form part of the group of which it is the representation of This construction can be done as part of normal configuration of the NoC elements, so that properties applied to each NoC element are applied to each element in the group. At 606, each NoC element of a given group can be replaced by the superset NoC element of the group, so as to create a simplified NoC.

In an example implementation, a user can select plurality of NoC elements that can be used to form a particular group with the help of a user interface. The selection of plurality of NoC elements to form one or more groups can be taken as input of the present method along with NoC specification and other restrictions or limitations of the NoC or a segment of NoC or of particular NoC elements/module/network elements. In an example implementation, the user input can include traffic profile of individual NoC elements and overall NoC, power profile of individual NoC elements and overall NoC, routing logics of individual NoC elements and overall NoC, and hierarchy/layer specification of different NoC elements.

In another implementation, the plurality of NoC elements can automatically be identified for formation of grouping based on similarity and/or compatibility of NoC elements. The methods and the systems of the present disclosure can analyze traffic behaviors, power profiles, and hierarchical details of all the NoC elements and can group them together, based on similarity or compatibility. In an example implementation, a hybrid combination of user selection and system selection of NoC elements can be used, such that similarity and/or compatibility of user selected NoC elements for groping can be check/validated by the method of present disclosure.

In an aspect, the methods of the present disclosure can include a step of receiving user inputs, such as NoC specification, traffic profile, voltage profile, channel/ports capacities of all the network elements, selection of plurality of NoC elements that can be grouped together to form one or more groups, desired cost constraints on the NoC, indication of number of unique module instances with which the NoC can be represented and limitations and restrictions of the NoC or a segment of NoC or of particular NoC elements/module/network elements. The received user inputs can be verified to ensure that the received inputs are compatible and non-conflicting.

In an example implementation, methods of the present disclosure can also automatically identify the plurality of NoC elements that can be merged together based on their properties/similarity/compatibility in case a user provides the maximum/total number of unique elements with which the user wishes to create the simplified NoC.

In an example implementation, one or more groups can be created based on similarity or compatibility of one or more properties of selected/chosen NoC elements, such as ports compatibility, channels compatibility, connection compatibility, power profiles compatibility, voltage profile compatibility and traffic profiles compatibility. In an example implementation, grouping of the plurality of NoC elements into one or more groups can be based on a hierarchy of the NoC elements. In an example implementation, the hierarchy of the plurality of NoC elements can either be determined/defined by user specification of hierarchical groups of NoC elements to be merged, or can be determined by automatic inference of hierarchical groups to merge, from the hierarchical group properties of NoC elements. In an example implementation, grouping of plurality NoC elements can be based on a user defined local/global cost limit, or user defined number of unique elements that can be included in a single group, or user defined hierarchy information.

In an example implementation, a recursive/greedy/opportunistic algorithm can be used for grouping the plurality of NoC elements so that a group can be created by recursively adding a NoC element and repeatedly calculating the total cost of grouping, until either the total number of NoC elements that can be added in a particular group exceeds a preselected limit, or the total cost of grouped NoC elements reaches a predefined limit. In a recursive implementation, the cost of the group can be repeatedly calculated when a new NoC element is added into the group and the number of NoC elements can be recursively added until the total cost of the group exceeds a predefined limit, or when the total number of unique superset NoC elements added in the group exceeds a predefined/desired limit of number of superset NoC elements. The recursive implementation can be used for creating one or more groups of the NoC elements in a similar manner. One can appreciate that plurality of NoC elements can be grouped together if they have some common properties, wherein such properties include, but are not limited to, Quality of Service (QoS) settings, single bit size, sidebands, first in first out (FIFO) depths and credits.

According to one example implementation, each superset NoC element that encompasses properties/capabilities/functionalities of all NoC elements that form part of the group to which the superset NoC element pertains, can be constructed/created/determined based on one or more of, merging the properties of compatible channels of the plurality of NoC elements of the corresponding group, resolving internal connectivity of the channels into a superset connectivity, and merging routing information associated with the plurality of NoC elements of the corresponding group.

In an example implementation, compatible channel(s) can include compatible ports and compatible virtual channels of the NoC elements that can be merged together. In an example implementation, merging of properties of compatible channels can include increasing/optimizing depth of virtual channel(s) of the superset NoC element, increasing/optimizing width of virtual channel(s) of the superset NoC element, enabling one or more virtual channels/ports of the superset NoC element, and increasing/optimizing buffer size of one or more ports of the superset NoC elements such that the increased/optimized channel properties encompass all properties/capabilities/functionalities of each of the plurality of NoC elements of a particular group. For example, if a first NoC element has a VC position enabled and a second NoC element has that particular VC position disabled, the merged NoC element can keep that particular VC enabled.

In an example implementation, resolving internal connectivity can include determining one or more conflicting paths/connectivity, and enabling one or more connectivity/paths of the superset NoC elements. In example implementation, superset NoC elements Esup of (E1, E2, . . . , En) will have its virtual channels (VCs) enabled if any of the NoC elements (E1, E2, . . . , En) have that particular port enabled. The superset Esup NoC element should be able to replace any of E1, E2 . . . , En without change in observed behavior of the NoC. In example implementation, input/output credits, width of VCs, and depths of VCs of the superset NoC element can be increased/optimized.

In example implementations, the merging of routing information associated with the plurality of NoC elements can include forming a consolidated routing table or routing logic for superset NoC elements incorporating all routing information and routing logic(s) of plurality of NoC elements of a particular group. In an example implementation, merging of routing information associated with the plurality of NoC elements can be based on identifier tags relating routing information to a corresponding NoC element, which indicates specific routing information for a particular NoC element of the group. For example, a consolidated routing table keeps record of all the routing logics/table associated with a particular NoC element against a unique identifier tag assigned to that particular NoC element. A unique identifier tag can be assigned to each NoC elements of the group that would be replaced by a superset NoC element, and all the routing logics/tables of that particular NoC element can be associated with the unique identifier tag. The unique identifier tag can be used to determine routing logic that the superset NoC elements may apply for routing the information on behalf of the NoC element. For example, if a first NoC element has three routing logics, and a second NoC element has five routing logics, wherein the three routing logics of the first NoC element are different from the five routing logics of second NoC element, superset NoC element may have eight (three plus five) routing logics, wherein the first three routing logics may be associated with a unique identifier tag, and other five routing logics may be associated with a second unique identifier tag.

In another aspect, the simplified NoC can be represented by a replacement of each of the plurality of NoC elements of a group with the superset NoC element corresponding to the group. In an example implementation, after replacing/representing the NoC with superset NoC elements or with minimized unique module instances, method of the present disclosure can further resolve connectivity conflicts between the one or more superset NoC elements and the plurality of NoC elements adjacent to the superset NoC elements.

In an example implementation, an opportunistic optimization technique can be used for selection of plurality of NoC elements that can be merge/replaced with a superset NoC element. In another example implementation, an opportunistic optimization technique can be used for placement and/or synthesization of simplified NoC elements.

In an example implementation, if the behavior/properties of the plurality of NoC elements do not match, NoC elements can modified by increasing/optimizing VCs depth, VCs width, and ports buffer size and/or decreasing/increasing/optimizing the VCs/ports input/output credits. In an example implementation, NoC elements can be pre-modified and/or can be modified in real time during merging.

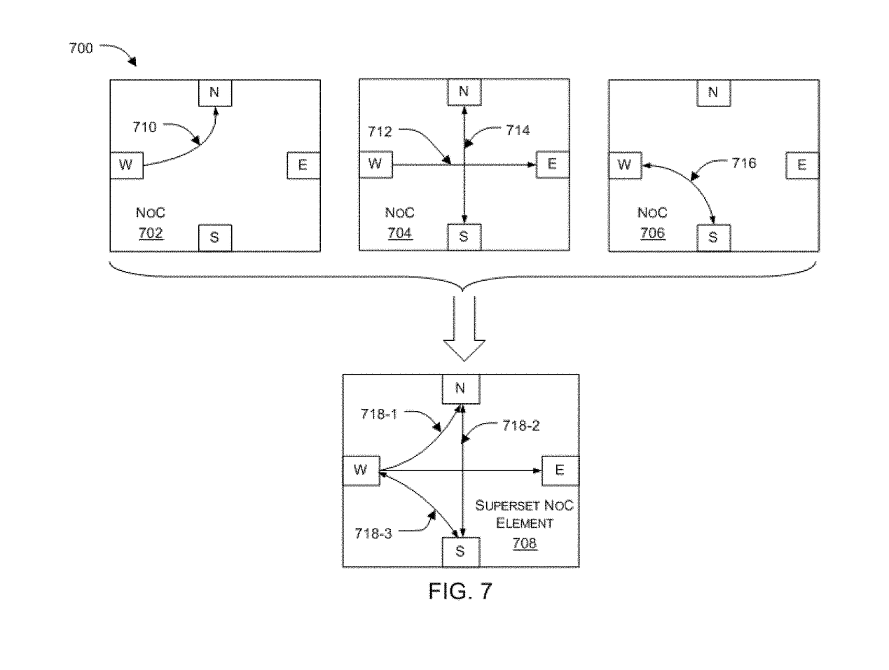

FIG. 7 illustrates an example connectivity resolution of superset NoC element created in accordance with an example implementation of the present disclosure. As shown in FIG. 7, three individual NoC elements, such as NoC element-1 702, NoC element-2 704, and NoC element-3 706 can be selected to form a group that can be merged together to form a superset NoC element 708. As can be seen in the FIG. 7, the NoC element-1 702 has a path 710 to forward packets (data or commands) received on west port (W) to north port (N) based of certain routing logic, NoC element-2 704 has a path 712 to forward packets received on west port (W) to east port (E),and a second bidirectional path 714 between north port(N) and south port(S). Similarly, NoC element-3 706 has a bidirectional path 716 to forward packets received on west port (W) to south port (S) and forward the packet received on south port (S) to west port (W). If a group formed of NoC element-1 702, NoC element-2 704, and NoC element-3 706 needs to be replaced by a superset NoC element 708, the superset NoC element 708 should have connectivity such that equivalent links for paths 710, 712, 714, 716 can be created between different ports of superset NoC element 708. Equivalent links such as link 718-1, 718-2, 718-3, and 718-4 can be created between different ports of superset NoC element 708 that are equivalent to paths 610-616 respectively. In an example implementation, superset NoC element 708 can encompass all connectivity of individual NoC elements with the help of a bit matrix representation.

In an example implementation, individual ports, for instance, north ports (N) of individual NoC elements, referred here as EP1, EP2, . . . , EPn can be grouped together to form a superset NoC north port represented here by EPsup, which can replace all the functionalities of all north ports of individual NoC elements. In an example implementation, when a superset port EPsup for a superset NoC element is created, other compatibilities such as compatibility of enabled VCs, QoS settings, single beat setting, sideband, FIFO depth, outgoing credits of superset element or ports of superset NoC elements can be checked. In example implementation, a compatibility check can be performed to ensure that the merged superset VCs and ports are compatible with the requirements and specification of NoC. In an instance, to ensure the compatibility, one or other VCs can be enabled VCs, QoS settings have to be the same, single beat, sideband, FIFO depth, and outgoing credits.

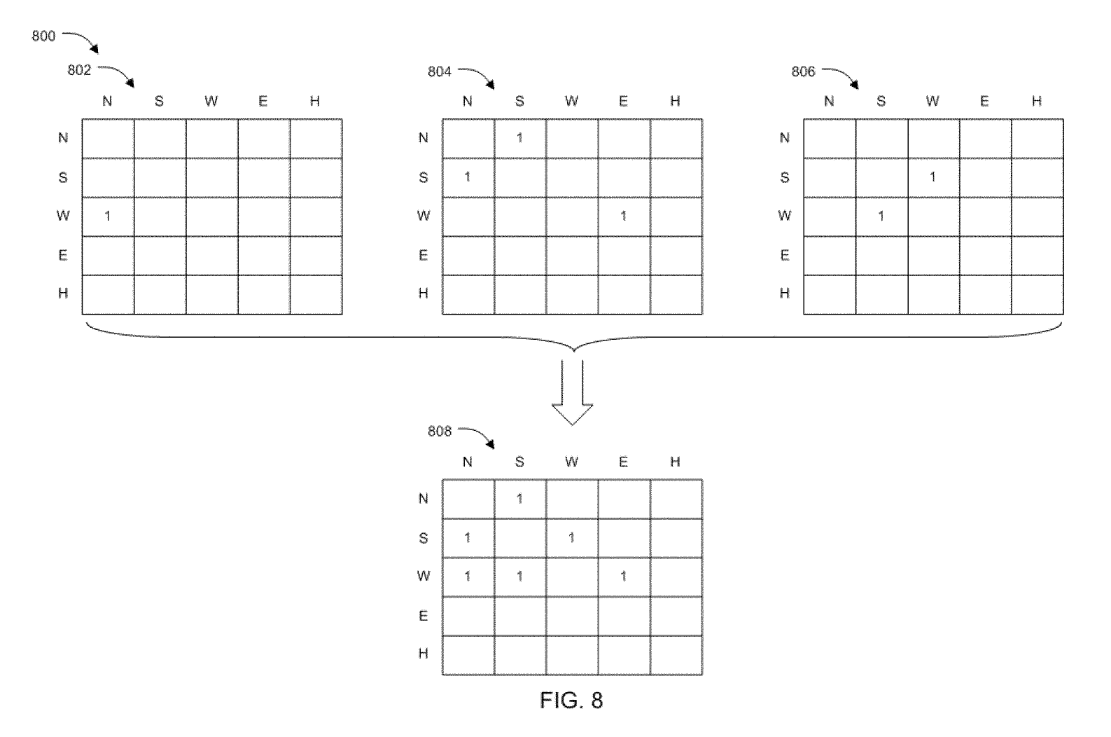

FIG. 8 illustrates progressive bit matrix representation for resolving connectivity conflict in accordance with an example implementation of the present disclosure. A bit matrix 802 represents connectivity between different ports of the example NoC element 702 that can receive data packets on west port (W) and forward the data packets to north port (N) as represented by value 1 in grid W*N. A bit matrix 804 represents connectivity between different ports of the example NoC element 704 that can receive data packets on west port (W) and forward said data packets to east port (E) as represented by value 1 in grid W*N, and a second bidirectional path between north port (N) and south port(S) as represented by value 1 in grid N*S and S*N. Another bit matrix 806 can be used to represent connectivity between different ports of the example NoC element 706 having a bidirectional path to forward packets received on west port (W) to south port (S) and forward the packet received on south port (S) to west port (W) as represented by value 1 in grid W*S and value 1 in grid S*W. A bit matrix 808 can be created for superset NoC element 708 such that it represents all possible connectivity of all individual NoC elements that are going to be replaced with superset NoC element 708.

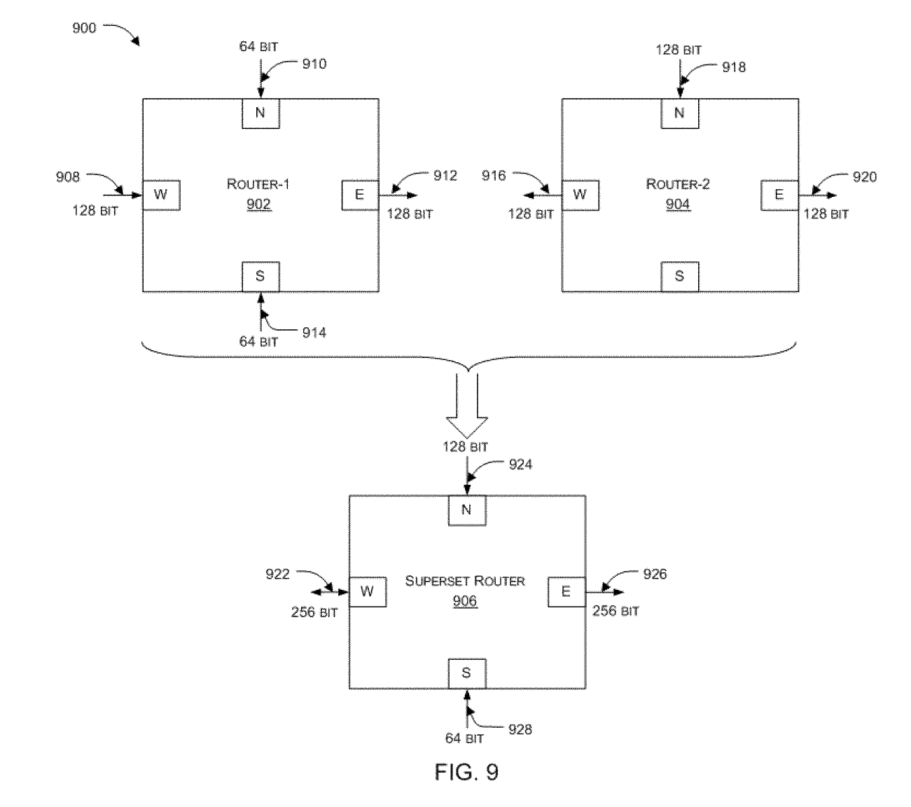

FIG. 9 illustrates input NoC elements (902 and 904) that can be merged to generate a superset element (906) in accordance with an example implementation of the present disclosure. An example NoC element 902 has its north port (N), west port (W), and south port (S) enabled for receiving data packets, and east port (E) enabled for forwarding data packet to another router/network element. Another NoC element 904 has its north port (N) enabled for receiving data packets and east port (E) and west port (W) enabled to forwarding packets to another routers/network element. In an example implementation, a superset NoC element can be determined/created to have its north port (N), south port (S), and west port (W) enabled for receiving data packets, and east port (E) and west port (W) enabled for forwarding data packets to another routers/network elements of the NoC. In an example implementation, a superset NoC element 906 can be created to have its north port (N), south port (S), and west port (W) enabled for receiving data packets and east port (E) and west port (W) enabled for forwarding data packets to another routers/network elements of the NoC. In an example implementation, superset NoC element 906 can have superset ports enabled/disabled so that it can be replaced for all the functionality of the ports of individual NoC elements.

In an example implementation, input/output credits, widths of VCs, and depths of VCs of the superset NoC element 806 can be increased/optimized. As shown in FIG. 9, NoC element 902 has an input VC 908 of width 128 bits connected to its west port (W), an input VC 910 of width 64 bits connected to its north port (N), and another input VC 914 of width 64 bits connected to its south port (S) and an output VC 912 of width 128 bits connected to its east port (E). Another NoC element 904 that can to be merged with NoC element 902 have an input VC 916 of width 128 bits, input VC 918 of width 128 bits, and output VC 920 of widths 128 bits. A superset NoC element 906 can have input/output VC 922 of width 128 bits connected to its west port (W), an input VC 924 of width 128 connected to its north port (N), an input VC 828 of width 64 bits connected to its south port (S), and an output VC 926 of width 128 bits connected to its east port (E). One can appreciate from the present illustration that channel size including depth and width of VCs of superset NoC elements can be similarly optimized/increased to encompass capabilities of all individual VCs of respective NoC elements that are grouped together. Credits of VCs and/or ports of superset NoC elements can similarly be optimized/increase/decreased.

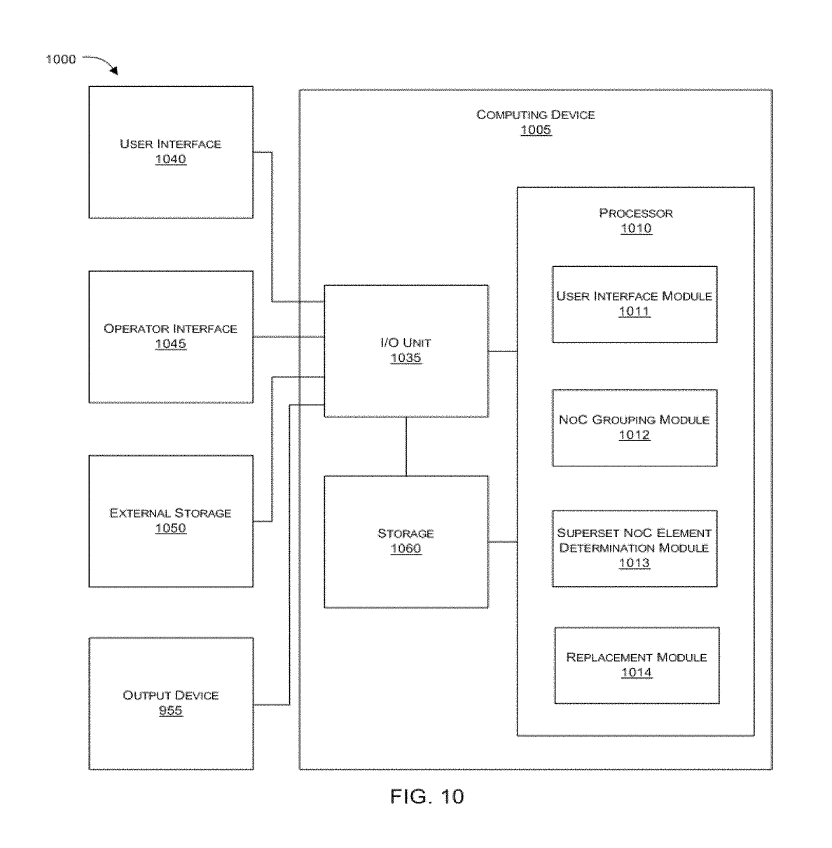

FIG. 10 illustrates an example computer system on which example implementation can be present disclosure can be executed in accordance with an example implementation of the present disclosure. The computer system 1000 includes a server 1005 which may involve an I/O unit 1035, storage 1060, and a processor 1010 operable to execute one or more units as known to one of skill in the art. The term “computer-readable medium” as used herein refers to any medium that participates in providing instructions to processor 1010 for execution, which may come in the form of computer-readable storage mediums, such as, but not limited to optical disks, magnetic disks, read-only memories, random access memories, solid state devices and drives, or any other types of tangible media suitable for storing electronic information, or computer-readable signal mediums, which can include carrier waves. The I/O unit processes input from user interfaces 1040 and operator interfaces 1045 which may utilize input devices such as a keyboard, mouse, touch device, or verbal command.

The server 1005 may also be connected to an external storage 1050, which can contain removable storage such as a portable hard drive, optical media (CD or DVD), disk media or any other medium from which a computer can read executable code. The server may also be connected an output device 1055, such as a display to output data and other information to a user, as well as request additional information from a user. The connections from the server 1005 to the user interface 1040, the operator interface 1045, the external storage 1050, and the output device 1055 may via wireless protocols, such as the 802.11 standards, Bluetooth® or cellular protocols, or via physical transmission media, such as cables or fiber optics. The output device 1055 may therefore further act as an input device for interacting with a user.

The processor 1010 may execute one or more modules including user interface module 1011, a NoC grouping module 1012, a superset NoC element determination module 1013, and a replacement module 1014. The user interface module 1011 may be configured to receive from a user a selection of NoC elements for forming one or more group, cost of merging or superset NoC creation, total/maximum number of desired unique module instances with which the simplified NoC can be created, SoC/NoC design, power profile specification containing voltage domain information, power domain information and power profile information, traffic flow information, one or more constrain of SoC and its component among other information that can be used for grouping the plurality of NoC elements. In example implementation, the user interface 1011 can also be configured to receive user input, current power status of one or more network element and any other external input.

In an example implementation, NoC grouping module 1012 can be configured to group plurality of NoC elements into one or more groups based on the user selection of NoC elements and other given limitations. In an example implementation, one or more groups can be created based on similarity or compatibility of one or more properties of selected/chosen NoC elements such as port compatibility, channel compatibility, connection compatibility, power profile compatibility, voltage profile compatibility, and traffic profiles. In an example implementation, grouping of the plurality of NoC elements into one or more groups can be based on a hierarchy of the NoC elements. In an example implementation, hierarchy of the plurality of NoC elements can either be determined/defined by user specification of hierarchical groups of NoC elements to be merged, or can be determined by automatic inference of hierarchical groups to merge, from the hierarchical group properties of NoC elements. In an example implementation, grouping of plurality NoC elements can be based on a user defined local/global cost limit, or user defined number of unique elements that can be included in a single group, or user defined hierarchy information.

In an example implementation, superset NoC element determination module 1013 can be configured to determine a superset NoC element for each of the one or more groups, wherein the superset NoC element can be configured to encompass behavior/capabilities/functionalities of plurality of NoC elements in the corresponding group. In an example implementation, superset NoC element determination module 1013 can be configured to determine/create a superset NoC element encompassing all properties/capabilities/functionality of all individual NoC elements of the group based on one or more of, merging properties of compatible channels of the plurality of NoC elements of the corresponding group, resolving internal connectivity of the channels into a superset connectivity, and merging of routing information associated with the plurality of NoC elements of the corresponding group.

In an example implementation, replacement module 1014 can be configured to replace each NoC element of a group by the superset NoC element that corresponds to that group in order to minimize the number of unique NoC elements.

Unless specifically stated otherwise, as apparent from the discussion, it is appreciated that throughout the description, discussions utilizing terms such as “processing,” “computing,” “calculating,” “determining,” “displaying,” or the like, can include the actions and processes of a computer system or other information processing device that manipulates and transforms data represented as physical (electronic) quantities within the computer system's registers and memories into other data similarly represented as physical quantities within the computer system's memories or registers or other information storage, transmission or display devices.

Example implementations may also relate to an apparatus for performing the operations herein. This apparatus may be specially constructed for the required purposes, or it may include one or more general-purpose computers selectively activated or reconfigured by one or more computer programs. Such computer programs may be stored in a computer readable medium, such as a computer-readable storage medium or a computer-readable signal medium. A computer-readable storage medium may involve tangible mediums such as, but not limited to optical disks, magnetic disks, read-only memories, random access memories, solid state devices and drives, or any other types of tangible or non-transitory media suitable for storing electronic information. A computer readable signal medium may include mediums such as carrier waves. The algorithms and displays presented herein are not inherently related to any particular computer or other apparatus. Computer programs can involve pure software implementations that involve instructions that perform the operations of the desired implementation.

Various general-purpose systems may be used with programs and modules in accordance with the examples herein, or it may prove convenient to construct a more specialized apparatus to perform desired method steps. In addition, the example implementations are not described with reference to any particular programming language. It will be appreciated that a variety of programming languages may be used to implement the teachings of the example implementations as described herein. The instructions of the programming language(s) may be executed by one or more processing devices, e.g., central processing units (CPUs), processors, or controllers.

As is known in the art, the operations described above can be performed by hardware, software, or some combination of software and hardware. Various aspects of the example implementations may be implemented using circuits and logic devices (hardware), while other aspects may be implemented using instructions stored on a machine-readable medium (software), which if executed by a processor, would cause the processor to perform a method to carry out implementations of the present disclosure. Further, some example implementations of the present disclosure may be performed solely in hardware, whereas other example implementations may be performed solely in software. Moreover, the various functions described can be performed in a single unit, or can be spread across a number of components in any number of ways. When performed by software, the methods may be executed by a processor, such as a general purpose computer, based on instructions stored on a computer-readable medium. If desired, the instructions can be stored on the medium in a compressed and/or encrypted format.

Moreover, other implementations of the present disclosure will be apparent to those skilled in the art from consideration of the specification and practice of the teachings of the present disclosure. Various aspects and/or components of the described example implementations may be used singly or in any combination. It is intended that the specification and example implementations be considered as examples only, with the true scope and spirit of the present disclosure being indicated by the following claims.

What is claimed is:

1. A method for simplifying a Network on Chip (NoC) Register Transfer Level (RTL), comprising:
automatically grouping the plurality of NoC elements specified in the NoC RTL into one or more groups based on one or more parameters;
determining a superset NoC element for each of the one or more groups, the superset NoC element configured to encompass capabilities of individual ones of the plurality of NoC elements in a corresponding group; and
reducing unique instances of modules in the NoC RTL through replacing each of the individual ones of the plurality of NoC elements in the corresponding group with the determined superset NoC element.

2. The method of claim 1, wherein the superset NoC element is constructed based on one or more of:
merging properties of compatible channels of the plurality of NoC elements in the corresponding group;
resolving internal connectivity of the channels into a superset connectivity; and
merging of routing information associated with the plurality of NoC elements.

3. The method of claim 2, wherein the merging of routing information associated with the plurality of NoC elements is based on identifier tags relating routing information to a corresponding NoC element.

4. The method of claim 1, wherein the grouping of the plurality of NoC elements into one or more groups is based on a hierarchy of the NoC elements, the hierarchy of the plurality of NoC elements determined either by user specification of hierarchical groups to merge, or by automatic inference of hierarchical groups to merge from hierarchical group properties.

5. The method of claim 1, wherein the grouping is based on a cost limit or number of unique elements.

6. The method of claim 5, wherein the plurality of NoC elements incurring a minimal cost increase are repeatedly identified and merged until total cost constraint or the number of unique elements is reached;
wherein elements incurring cost increase within a threshold are automatically identified and merged.

7. The method of claim 1, further comprising resolving connectivity between the superset NoC element and the plurality of NoC elements adjacent to the superset NoC elements by modification of the plurality of NoC elements not part of the group to be replaced by the superset.

8. The method of claim 7, the resolving connectivity comprising reprocessing the plurality of NoC elements that are merged into another superset element that interact with the plurality of NoC elements in the group to be replaced by the superset.

9. A non-transitory computer readable medium, storing instructions for simplifying a Network on Chip (NoC) Register Transfer Level (RTL), comprising:
automatically grouping the plurality of NoC elements specified in the NoC RTL into one or more groups based on one or more parameters;
determining a superset NoC element for each of the one or more groups, the superset NoC element configured to encompass capabilities of individual ones of the plurality of NoC elements in a corresponding group; and
reducing unique instances of modules in the NoC RTL through replacing each of the individual ones of the plurality of NoC elements in the corresponding group with the determined superset NoC element.

10. The non-transitory computer readable medium of claim 9, wherein the superset NoC element is constructed based on one or more of:
merging properties of compatible channels of the plurality of NoC elements in the corresponding group;
resolving internal connectivity of the channels into a superset connectivity; and
merging of routing information associated with the plurality of NoC elements.

11. The non-transitory computer readable medium of claim 10, wherein the merging of routing information associated with the plurality of NoC elements is based on identifier tags relating routing information to a corresponding NoC element.

12. The non-transitory computer readable medium of claim 9, wherein the grouping of the plurality of NoC elements into one or more groups is based on a hierarchy of the NoC elements, the hierarchy of the plurality of NoC elements determined either by user specification of hierarchical groups to merge, or by automatic inference of hierarchical groups to merge from hierarchical group properties.

13. The non-transitory computer readable medium of claim 9, wherein the grouping is based on a cost limit or number of unique elements.

14. The non-transitory computer readable medium of claim 13, wherein the plurality of NoC elements incurring a minimal cost increase are repeatedly identified and merged until total cost constraint or the number of unique elements is reached;
wherein elements incurring cost increase within a threshold are automatically identified and merged.

15. The non-transitory computer readable medium of claim 9, the instructions further comprising resolving connectivity between the superset NoC element and the plurality of NoC elements adjacent to the superset NoC elements by modification of the plurality of NoC elements not part of the group to be replaced by the superset.

16. The non-transitory computer readable medium of claim 15, the resolving connectivity comprising reprocessing the plurality of NoC elements that are merged into another superset element that interact with the plurality of NoC elements in the group to be replaced by the superset.
